(19) United States
(12) Patent Application Publication
(10) Pub. No.: US 2005/0078629 A1
(43) Pub. Date: Apr. 14, 2005

(54) Channel allocation extension in wireless communications networks and methods

(76) Inventors: Hao Bi, Wheeling, IL (US); John D. Reed, Arlington, TX (US); Jack A. Smith, Bedford, TX (US)

Correspondence Address: MOTOROLA INC, 600 NORTH US HIGHWAY 45, ROOM AS437, LIBERTYVILLE, IL, 60048-5343, US

(21) Appl. No.: 10/685,372

(22) Filed: Oct. 14, 2003

(51) Int. Cl. H04Q 7/00

(52) U.S. Cl. 370/329; 370/341

(57) ABSTRACT

A method (300) in a wireless communications network infrastructure entity, including determining (310) that a wireless communications device has discontinued transmission on an allocated channel, indicating (340) to the wireless communications device whether the channel allocation to the wireless communications device is extended for example, using rate control information transmitted to the wireless communications device after the wireless communications device discontinued transmission. The transmission rate for the extended channel allocation may be changed based on the transmission rate control information or based on secondary transmission rate information.

### CROSS REFERENCE TO RELATED APPLICATIONS

The present application is related to copending application Ser. No. ______ entitled “Resource Negotiation in Wireless Communications Networks And Methods”, Atty. Docket No. CS23600RL, filed on 15 Sep. 2003, having a common assignee, the subject matter of which is incorporated herein by reference

### FIELD OF THE DISCLOSURE

The present disclosure relates generally to channel resource allocation in wireless communications systems, and more particularly to the extension of channel resource allocations to wireless communications devices under circumstances that would otherwise result in the expiration or termination of the channel allocation, and to corresponding methods in wireless communications devices and networks.

### BACKGROUND OF THE DISCLOSURE

In some wireless communications networks, mobile stations may transmit at preferred higher data rates only upon first obtaining a data channel assignment from the network. An autonomous data rate, for which a prior channel assignment is not required, is generally the lowest data rate available. In CDMA 2000, release D, for example, the mobile station (MS) requests a data channel assignment by sending a Supplemental Channel Request Message (SCRM) to the network indicating how much data the MS has in its buffer. The channel assignment message from the network in the CDMA 2000 protocol is a Supplemental Channel Assignment Message (SCAM) or an Enhanced Supplemental Channel Assignment Message (ESCAM), which includes more information than a SCAM. The E/SCAM messages include a scheduling period over which the MS may transmit data at an assigned data rate. In the existing CDMA 2000 protocol, the data channel request and assignment messaging occurs at Layer 3 in the architecture.

In the 3^{rd} Generation Partnership Project 2 (3GPP2), Technical Specification Group C (TSG-C) Work Group 3 (WG3) has proposed an alternative data scheduling and rate control scheme including overhead channels that may replace the existing E/SCAM scheme. In prior art FIG. 1, under the WG3 proposal, the network transmits a scheduling (grant) message 120 on a forward link (FL) Grant Channel (F-GCH) in response to a request message 110 from the MS on the reverse link (RL). The grant message assigns a data rate, e.g. 76.8 kbits/s, for the MS to transmit one encoder packet. Thereafter, upon successfully transmitting the encoder packet, the MS may continue to transmit data subject to a rate control command sent by the network on the forward link. The rate control command permits the network to adjust the data rate up or down one step at a time. The rate control command is sent prior to the frame whose rate the command controls. In FIG. 1, for example, the rate control command (RC) 130 sent during frame 140 controls the rate on future frame 142, RC 132 sent during frame 142 controls the rate of frame 144, etc. In the scheme proposed by 3GPP2 TSG-C WG3, the data rate may be maintained from one frame to the next.

An alternative proposal by 3GPP2 TSG-C WG3 is a modified grant message having an additional bit to disable the rate control command after transmitting one encoder packet. The effect of disabling the rate command enables the network to limit the data channel assignment to the one encoder packet. Thus, the MS must request a new data channel assignment for transmitting packets in addition to the original encoder packet.

In the existing CDMA 2000 data channel assignment protocol, the channel assignment is for a fixed period starting at a specified time. In the TSG-C WG3 proposals discussed above, the channel assignment is lost when there is a gap in transmission. FIG. 1 illustrates loss of the channel assignment upon completion of the transmission of data in frame 144, e.g., when the MS buffer is emptied, or upon discontinuous transmission (DTX), e.g., for lack of sufficient transmission power due to channel fading. In prior art FIG. 1, data transmission resumes in frame 146 only upon receipt of a new grant 122 in response to a new request 112 transmitted by the MS on the reverse link. Cumulative channel assignment negotiation generally has an adverse impact on reverse and forward link capacity and may result latency. The CDMA 2000 protocol permits the MS to transmit data without a channel assignment, but the data rate is relatively low, on the theory that the network has inadequate forewarning, which is necessary to allocate resources to accommodate the transmission.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates a prior art data channel request and usage scheme.

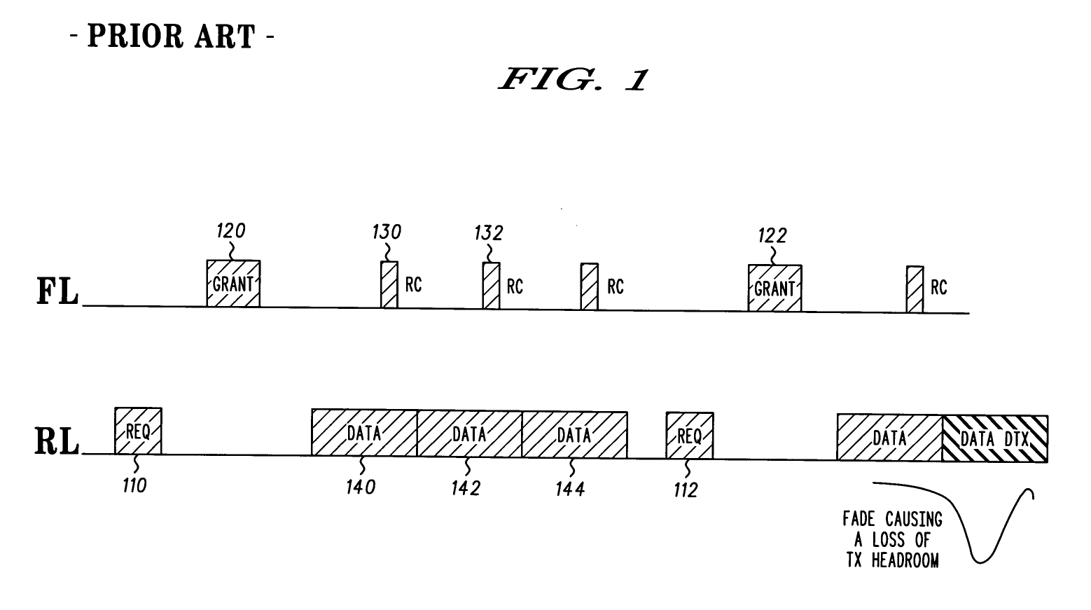

FIG. 2 illustrates an exemplary wireless communications network.

FIG. 3 is an exemplary process diagram for extending a channel allocation to a wireless communications device.

FIG. 4 illustrates an exemplary channel allocation and extension scheme.

### DETAILED DESCRIPTION

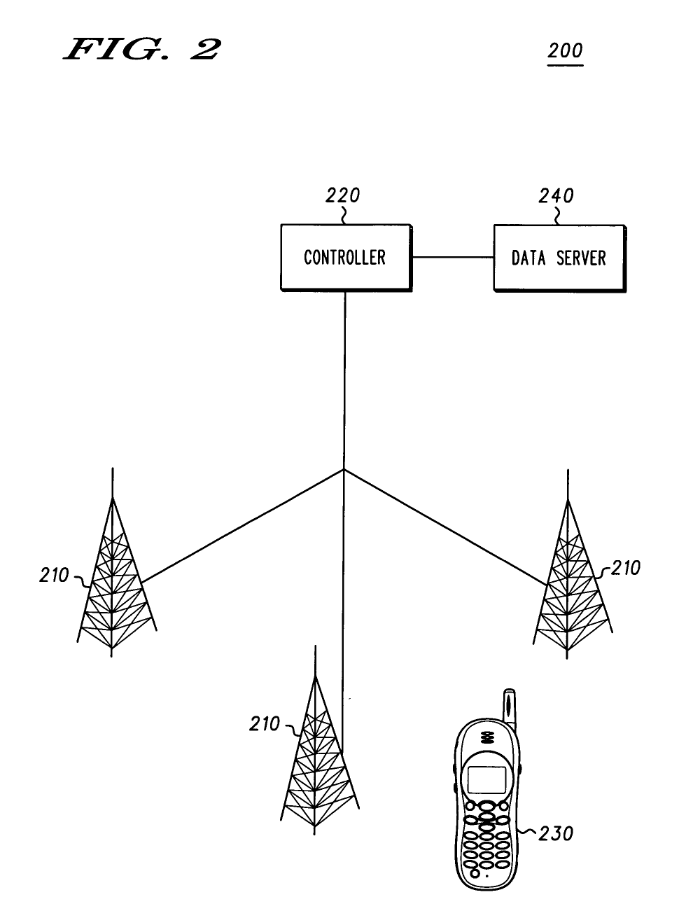

FIG. 2 illustrates exemplary wireless communications network infrastructure 200 comprising a plurality of base stations 210 communicably coupled to a controller 220. The infrastructure may also include core network infrastructure, for example, a mobile switching center and/or packet data network or gateway not illustrated but known generally. A wireless communications device 230 communicates with other devices via one or more base stations when connected to the network. The exemplary network 200 is also coupled to a data server 240, usually by a gateway not illustrated but known in the art, thus providing data services to wireless communications devices in the network. In one embodiment, the wireless communications network is a CDMA 2000 network, although in other embodiments the network conforms to some other communications protocol, for example, 3^{rd} Generation Partnership Project (3GPP) Universal Mobile Telephone System (UMTS) wireless communications W-CDMA communications systems, among other.

Generally, the communications network allocates radio resources to wireless communications devices in the network. In FIG. 2, for example, one of the base stations 210 serving the wireless communications device 230 assigns radio resources, for example, a data channel assignment and possibly a data rate, to the wireless communications device 230. In some embodiments, the radio resource assignment is made in response to a radio resource request from the wireless communications device, although in other embodiments the wireless communications device need not specifically request the channel assignment or allocation from the network.

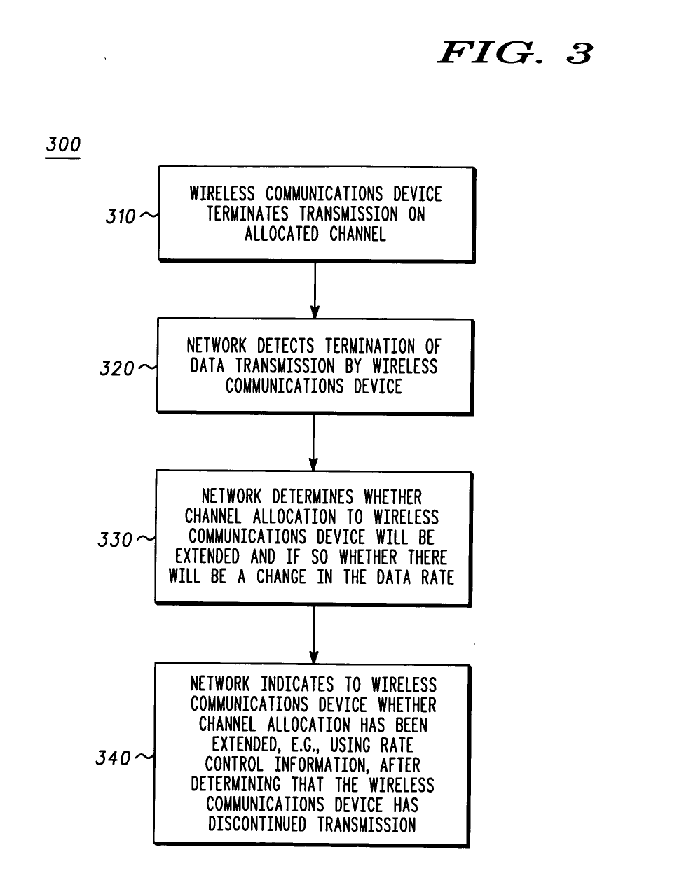

In the process diagram 300 of FIG. 3, at block 310, a wireless communications device terminates or interrupts the transmission of information, for example, data, on an allocated channel. The transmission may be terminated or discontinued (DTX) due to an exhaustion of the data or information being transmitted or it may be interrupted or discontinued due to signal fading or for some other reason, which is not particularly material to the instant disclosure. In some wireless communications protocols, including the CDMA 2000 protocol, the channel allocation expires or terminates upon cessation or interruption or termination of the transmission, whereupon the wireless communications device must obtain another channel assignment, exemplary procedures for which are discussed further below.

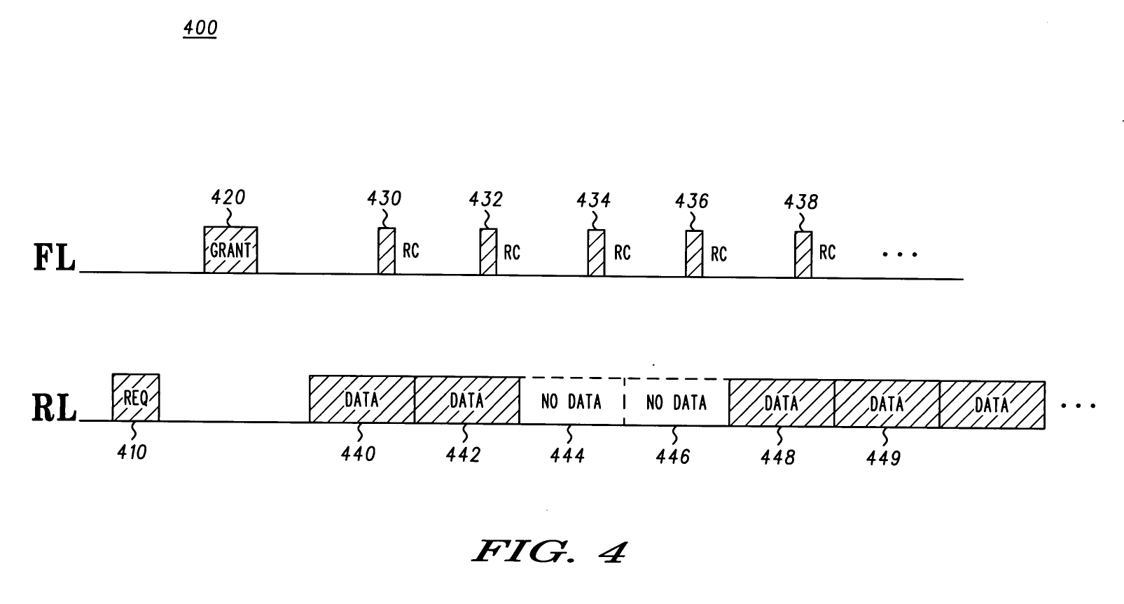

In the exemplary communications diagram 400 of FIG. 4, the wireless communications device transmits a channel request 410 on a reverse link (RL) to the network, which responds with a channel grant 420 on a forward link (FL). The channel grant may include explicit transmission rate information. Alternatively, a default rate may be implied absent an explicit indication by the network. In other embodiments, the wireless communications device may obtain a channel allocation autonomously. In CDMA 2000, networks, for example, the wireless communication device may transmit data without first requesting a channel grant from the network, but the self-allocated channel may be subject to a relatively low data transmission rate in comparison to the rate granted in response to an explicit channel request. The source of the channel allocation is generally immaterial insofar as the instant disclosure us concerned. Upon obtaining a channel allocation, the wireless communications device transmits data or other information on the allocated channel, for example, in a sequential frame-by-frame manner.

In some wireless communications protocols, including CDMA 2000, the network uses rate control information to control the transmission rate of the wireless communications device while the wireless communications device transmits on the allocated channel. In the exemplary diagram of FIG. 4, the network transmits rate control (RC) information 430 to the wireless communications device transmitting in frame 440. The rate control information 430 is used by the wireless communications device to adjust its transmission rate, for example, up or down a step, in a subsequent frame, for example, frame 442. Similarly, the rate control information 432 is used by the wireless communications device to adjust the transmission rate in the subsequent frame 444, assuming that data is transmitted. In some embodiments, the absence of the rate control information during data transmission is an indication that there is no change in the transmission rate. According to this mode of operation, for example, the absence of rate control information 432 in frame 442 would indicate that the transmission rate in frame 444 remains unchanged relative to the transmission rate in prior frame 442.

In FIG. 3, at block 320, a wireless communications network infrastructure entity, for example, a base station or controller or some other entity, determines whether there has been an interruption in transmission by the wireless communications device. In one embodiment, the network detects a transmission interruption of the wireless communications device by monitoring a data control channel, for example, the Reverse Data Control Channel (R-DCCH) in CDMA2000, on which the wireless communications device transmits. The absence of information on the data control channel may be used to indicate that the wireless communications device has discontinued transmitting on the data channel, for example, on the Reverse Packet Data Channel (R-PDCH) in CDMA 2000. Alternatively, the wireless communications device may include some signaling on the data control channel, for example, a DTX flag, indicating to the network that the wireless communications device has discontinued transmission. In another exemplary embodiment, the network may detect that the wireless communications device has discontinued transmission based on an estimation of power on the data channel or based on an estimation of power on the data control channel on which the wireless communications device transmits. In another embodiment, the network determines that the wireless communications device has discontinued transmission based on decoding a data channel on which the wireless communication device transmits. For example, if the network is unable to successfully decode the data channel, e.g., by performing a successful Cyclical Redundancy Check (CRC), over multiple sequential frames, there may be a likelihood that transmission has been discontinued, though this scheme may require more time than others to determine whether the wireless communications device has discontinued transmission. In other embodiments, other schemes may be used to determine whether the wireless communications device has terminated data transmission.

FIG. 4 illustrates discontinued transmission in frames 444 and 446 on the reverse link (RL) by the wireless communications device after transmission in frames 440 and 442. In some networks, discontinuance of transmission by the wireless communications device ordinarily results in loss of the channel assignment. In some instances, the network may send rate control information to the wireless communications device during the first frame during which the wireless communications device discontinues transmission depending upon whether the network is able to determine whether the transmission has been discontinued before the rate control information is transmitted. Thus in FIG. 4, the network transmits a rate control signal 434 on the forward link (FL) in data-less frame 444 following the frame 442. Rate control information ordinarily terminates when the wireless communications device discontinues transmission on the allocated channel.

In FIG. 3, at block 330, upon determining that the wireless communications device has discontinued transmission, the network determines whether the prior channel allocation to the wireless communications device will be extended or allowed to expire, and if extended whether the transmission rate should remain the same or be changed. These decisions related to channel allocation extension and the transmission rate may be based on one or more factors including, among others, network load and capacity, channel conditions, quality of service requirements, etc. Though, generally, different network operators will use different criteria for determining whether to extend a channel allocation and whether to make any rate changes.

In FIG. 3, at block 340, a wireless communications network infrastructure entity indicates to the wireless communications device whether the channel allocation will be extended, after determining that the wireless communications device has discontinued transmission. In one embodiment, the network indicates, to the wireless communications device, whether or not it will extend the channel allocation by using rate control information transmitted to the wireless communications device.

In one embodiment, the network sends rate control information to the wireless communications device to indicate that the channel allocation has been extended after the wireless communications device discontinues transmission. According to this aspect of the disclosure, the presence of rate control information, e.g., one or more rate control bits, which under ordinary circumstances would not be present after transmission cessation (except possible the first frame thereafter as discussed above), indicates to the wireless communications device that the network has extended the channel allocation. The wireless communications device interprets transmission rate control information received after terminating the transmission as an indication that the channel allocation has been extended beyond the time during which the transmission was terminated. In another embodiment, the absence of the rate control information indicates that the channel allocation has not been extended. In one embodiment, for example, where the rate control information is a single bit, the existence of the rate control bit after transmission is discontinued indicates that the channel allocation has been extended, and the absence of the rate control bit indicates that the channel allocation has not been extended.

In one embodiment, the rate control information indicating whether the channel allocation has been extended is sent in the frame after the frame during which the wireless communications device discontinued transmission, since the network may not be able to determine that the transmission was discontinued before transmitting the rate control information in the first frame during which transmission has been discontinued. In FIG. 4, for example, the rate control information 436 transmitted on the forward link in empty frame 446 indicates that the channel allocation has been extended. In other embodiments, however, rate control information 434 may be used to indicate whether the channel allocation has been extended.

In one embodiment, the network changes the transmission rate at the same time the channel allocation is extended. In one embodiment, the transmission rate is changed using the transmission rate control information indicating that the channel allocation has been extended. In the exemplary embodiment where the rate control information is a single bit having a polarity attribute, i.e., negative or positive, a positive bit (RC=+1) may be used to indicate that the channel allocation has been extended at the prior rate, and a negative bit (RC=−1) may be used to indicate that the channel allocation has been extended at a lesser rate, for example, at a rate decreased by single step relative to the rate before transmission was discontinued. Other schemes may be used alternatively. The use of additional bits permits increasing the amount of information that may be encoded in the transmission rate control message.

In another embodiment, the transmission rate for the extended channel allocation is a secondary rate, for example, the autonomous rate. In another embodiment, secondary rate information is communicated to the wireless communications device, for example, the network may send secondary transmission rate information to the wireless communications device in a signaling and control message, e.g., a Layer 3 message, before or after extending the channel allocation. In one embodiment, the secondary rate information specifies a hard transmission rate, for example, the autonomous rate or a rate greater than the autonomous rate but less than the previous rate. In another embodiment, the secondary rate information indicates how many steps below the previous rate the extended rate is to be reduced. Thus in FIG. 4, the rate control information 436 transmitted on the forward link in frame 446 may also be used in some embodiments to communicate transmission different types of rate information to the wireless communications device.

In embodiments where the wireless communications device uses secondary rate information, the use of the secondary rate information may or may not be conditional. In some embodiments, the secondary rate is the default rate. In other embodiments, the secondary rate is used only upon satisfaction of a condition. In one conditional embodiment where a single rate control bit has polarity attributes, for example, a positive bit (RC=+1) may indicate that the rate is a previous rate, and a negative bit (RC=−1) may indicate that the secondary rate applies. In FIG. 4, for example, the rate control information 436 transmitted on the forward link in frame 446 may be also used in some embodiments to invoke use of secondary rate information.

Upon communicating the channel allocation extension and any transmission rate information to the wireless communications device, the wireless communications device resumes transmission on the allocated channel at any new required transmission rate. In FIG. 4, for example, upon receiving the rate control information 436 from the network on the forward link, the wireless communications device resumes transmitting data at the newly specified transmission rate in frames 448, 449, etc. Any subsequent rate control information, for example, rate control bit 438, received by the wireless communications device is used to adjust the transmission rate as discussed above in connection with the discussion of rate control information 430 & 432.

While the present disclosure and the best modes thereof have been described in a manner establishing possession and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a wireless communications network infrastructure entity, the method comprising:
determining that a wireless communications device has discontinued transmission on an allocated channel;
extending the channel allocation to the wireless communications device after determining that the wireless communications device discontinued transmission;
terminating the channel allocation if the channel allocation is not extended.

2. The method of claim 1,
transmitting transmission rate control information to the wireless communications device to which the channel has been allocated while the wireless communications device transmits on the allocated channel;
extending the channel allocation using the transmission rate control information after determining that the wireless communications device discontinued transmission.

3. The method of claim 2,
not extending the channel allocation by not transmitting transmission rate control information after determining that the wireless communications device discontinued transmission.

4. The method of claim 2,
changing the transmission rate using the transmission rate control information at the same time the channel allocation is extended.

5. The method of claim 2,
sending a signaling and control message with secondary transmission rate information,
the secondary transmission rate for determining a transmission rate for when the channel allocation is extended.

6. The method of claim 1,
transmitting transmission rate control information to the wireless communications device to which the channel has been allocated in at least some frames during which the wireless communications device transmits on the allocated channel, the transmission rate control information controlling a transmission rate for a frame subsequent to the frame during which the transmission rate control information is transmitted;
extending the channel allocation by transmitting transmission rate control information in the frame after the frame during which the wireless communications device discontinued transmission.

7. The method of claim 1,
determining that the wireless communications device discontinued transmission by monitoring a data control channel on which the wireless communications device transmits; and
determining whether the channel allocation will be maintained in response to determining that the wireless communications device discontinued transmission.

8. The method of claim 1,
determining that the wireless communications device discontinued transmission based on a power estimation on a data channel on which the wireless communications device transmits,
determining whether the channel allocation will be maintained in response to determining that the wireless communications device discontinued transmission.

9. The method of claim 1,
determining that the wireless communications device discontinued transmission based on decoding a data channel on which the wireless communication device transmits.

10. A method in a wireless communications network infrastructure entity, the method comprising:
determining that a wireless communications device has discontinued transmission on an allocated channel;
indicating to the wireless communications device whether the channel allocation to the wireless communications device is extended, after determining that the wireless communications device discontinued transmission, using rate control information transmitted to the wireless communications device after the wireless communications device discontinued transmission.

11. The method of claim 10,
transmitting transmission rate control information to the wireless communications device to which the channel has been allocated, the transmission rate control information controlling a transmission rate of the wireless communications device,
extending the channel allocation to the wireless communications device, after determining that the wireless communications device discontinued transmission, by transmitting transmission rate control information after determining that the wireless communications device discontinued transmission.

12. The method of claim 11,
changing the transmission rate of the extended channel allocation, relative to a transmission rate prior to when the wireless communications device discontinued transmission, using a polarity attribute of the transmission rate control information used to extend the channel allocation.

13. The method of claim 11,
changing the transmission rate of the extended channel allocation, relative to a transmission rate prior to when the wireless communications device discontinued transmission, by transmitting secondary transmission rate information to the wireless communications device on a signaling and control channel.

14. The method of claim 10,
transmitting transmission rate control information to the wireless communications device to which the channel has been allocated, the transmission rate control information controlling a transmission rate of the wireless communications device,
not extending the channel allocation by not transmitting the transmission rate control information to the wireless communications device after determining that the wireless communications device discontinued transmission.

15. A method in a wireless communications device, the method comprising:
terminating transmission on an allocated channel;
receiving transmission rate control information after terminating the transmission,
interpreting the transmission rate control information received after terminating the transmission on the allocated channel as an indication that the channel allocation has been extended beyond the time during which the transmission was terminated.

16. The method of claim 15,
receiving transmission rate control information during at least some frames while transmitting before terminating transmission,
controlling the transmission rate using the transmission rate control information received while transmitting.

17. The method of claim 15,
transmitting on the allocated channel, after the channel allocation has been extended, at a transmission rate different than a transmission rate before terminating the transmission.

18. The method of claim 17,
transmitting on the allocated channel, after the channel allocation has been extended, at a transmission rate based on the transmission rate control information received after terminating the transmission.

19. The method of claim 17,
receiving a signaling and control message with secondary transmission rate information,
transmitting on the allocated channel, after the channel allocation has been extended, at a transmission rate based on the secondary transmission rate information.

20. The method of claim 19,
transmitting on the allocated channel, after the channel allocation has been extended, at a transmission rate based on the secondary transmission rate information conditioned on a polarity attribute of the transmission rate control information received after terminating the transmission.
